(19) United States
(12) Patent Application Publication
(10) Pub. No.: US 2022/0351897 A1
(43) Pub. Date: Nov. 3, 2022

(54) ELECTROMAGNETIC INDUCTION DEVICE WITH ON-LOAD TAP CHANGER

(71) Applicant: HITACHI ENERGY SWITZERLAND AG, Baden (CH)

(72) Inventors: Tommy LARSSON, Ludvika (SE); Jean MATHAE, Ludvika (SE)

(73) Assignee: HITACHI ENERGY SWITZERLAND AG, Baden (CH)

(21) Appl. No.: 17/624,218

(22) PCT Filed: Jun. 30, 2020
(86) PCT No.: PCT/EP2020/068328

§ 371 Date: Dec. 30, 2021

(30) Foreign Application Priority Data
Jul. 1, 2019 (EP) 19183665.9

(51) Int. Cl. H01F 29/02; H01F 27/24; H01F 27/02

(52) U.S. Cl. CPC H01F 29/025; H01F 27/24; H01F 27/02

(57) ABSTRACT

An electromagnetic induction device includes: a main tank, a magnetic core arranged in the main tank, an On-Load Tap Changer, OLTC, comprising: an OLTC tank mounted to the main tank, a fine selector, a diverter switch, a change-over selector, and a customer interface; and a barrier separating the main tank from the OLTC tank, wherein the diverter switch and the change-over selector are arranged in the OLTC tank, and the fine selector and customer interface are arranged in the main tank, and wherein the barrier comprises a plurality of electrical connections configured to connect the diverter switch and the change-over selector to the fine selector.

### CROSS REFERENCE TO RELATED APPLICATIONS

This application is a 35 U.S.C. § 371 national stage application of PCT International Application No. PCT/EP2020/068328 filed on Jun. 30, 2020, which claims priority to European Patent No. 19183665.9 filed on Jul. 1, 2019, the disclosure and content of each which is incorporated by reference herein in its entirety.

### TECHNICAL FIELD

The present disclosure generally relates to electromagnetic induction devices, and in particular to electromagnetic induction devices provided with an on-load tap changer.

### BACKGROUND

Electromagnetic induction devices such as power transformers and reactors may be provided with On-Load Tap Changers (OLTC) for enabling stepped voltage regulation of the electromagnetic induction device as a means for voltage compensation when the electromagnetic induction device is On-Load, i.e. connected to a transmission or distribution network.

An OLTC unit which comprises a tap changer mechanism can either be of in-tank type or on-tank type. If the OLTC unit is arranged inside the electromagnetic core housing, i.e. the transformer tank or reactor tank, it is of in-tank type. If the OLTC unit is mounted to the electromagnetic core housing, it is of an-tank type. For the latter type of OLTC unit, the tap changer mechanism is separated from the interior of the electromagnetic core housing by means of an insulation barrier. The insulation barrier comprises electrical connections and acts as an interface between windings inside the electromagnetic core housing and the tap changer mechanism in the OLTC unit. Moreover, the insulation barrier separates dielectric fluid in the electromagnetic core housing from dielectric fluid in the OLTC unit, preventing mixing of the dielectric fluids and thus reducing the risk of one dielectric fluid contaminating the other.

U.S. Pat. No. 6,856,122 discloses a thyristor tap changer for uninterrupted switching over between different winding taps of a tapped transformer under load.

EP3293743 discloses a cover for electric power devices filled with dielectric liquid.

### SUMMARY

An object of the present disclosure is to provide an electromagnetic induction device which solves or at least mitigates existing problems of the state of the art.

There is hence provided an electromagnetic induction device comprising: a main tank, a magnetic core arranged in the main tank, an On-Load Tap Changer, OLTC, comprising: an OLTC tank mounted to the main tank, a fine selector, a diverter switch, a change-over selector, and a customer interface; and a barrier separating the main tank from the OLTC tank, wherein the diverter switch and the change-over selector are arranged in the OLTC tank, and the tap selector and customer interface are arranged in the main tank, and wherein the barrier comprises a plurality of electrical connections configured to connect the diverter switch and the change-over selector to the fine selector.

The diverter switch and the change-over selector are devices that potentially can generate gas due to current commutation sparks and heat dissipation and/or have fast mechanics. The fine selector and the customer interface cannot potentially generate gas nor do they have fast mechanics. Since the diverter switch and the change-over selector are arranged in the OLTC tank, the main tank can be kept clean from contamination. Additionally, since only the diverter switch and the change-over selector of the diverter switch, the change-over selector, the fine selector, and the customer interface are arranged in the OLTC tank, the OLTC tank may be made more compact. The electromagnetic induction device may thereby be made more compact, with a smaller footprint.

The fine selector may also be referred to as a fine tap selector.

The diverter switch and the change-over selector may be integrated.

The fine selector and the customer interface may be integrated. The main tank can thereby be made smaller.

According to one embodiment main tank is filled with a first dielectric liquid and the OLTC tank is filled with a second dielectric liquid, and wherein the barrier separates the first dielectric liquid from the second dielectric liquid.

According to one embodiment the diverter switch and the change-over selector are arranged on an OLTC side of the barrier.

According to one embodiment the change-over selector is arranged between the diverter switch and the barrier.

According to one embodiment the fine selector and customer interface are arranged on a main tank side of the barrier.

According to one embodiment the fine selector is arranged between the customer interface and the barriers.

The barrier may have material properties and a thickness which enables carrying the weight of the diverter switch, the change-over selector, the fine selector and the customer interface. These components may for three phase electromagnetic induction devices together weigh in the range of 100-200 kg.

According to one embodiment the barrier comprises an electrically insulating material.

According to one embodiment the barrier comprises a polymer-based material.

According to one embodiment the barrier comprises at least one of glass fiber and epoxy.

According to one embodiment the electromagnetic induction device is a high voltage electromagnetic induction device. With high voltage is meant voltages typically starting at 36 kV and up to 145 kV.

According to one embodiment the electromagnetic induction device is a transformer, such as a power transformer, or a reactor.

The OLTC may be a one-phase, two-phase or three-phase OLTC, each phase comprising a respective fine selector, diverter switch, change-over selector and customer interface, the diverter switch and change-over selector of each phase being arranged in the OLTC tank and the fine selector and the customer interface of each face being arranged in the main tank.

Each diverter switch and change-over selector may be mounted to an OLTC side of the barrier.

For each phase, the change-over selector may be arranged between the barrier and the corresponding diverter switch.

Each fine selector and customer interface may be mounted to the main tank side of the barrier.

For each phase, the fine selector may be arranged between the barrier and the customer interface.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc.”, unless explicitly stated otherwise.

### BRIEF DESCRIPTION OF THE DRAWINGS

The specific embodiments of the disclosure will now be described, by way of example, with reference to the accompanying drawings, in which:

FIG. 1 is a schematic side view of an example of an electromagnetic induction device;

FIG. 2 shows an electric diagram of an example of an OLTC configuration;

FIG. 3 shows an electric diagram of another example of an OLTC configuration; and

FIG. 4 schematically shows a section of the electromagnetic induction device in FIG. 1 depicting a schematic mechanical structure of an OLTC.

### DETAILED DESCRIPTION

The present disclosure will now be described more fully hereinafter with reference to the accompanying drawings, in which exemplifying embodiments are shown. The present disclosure may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

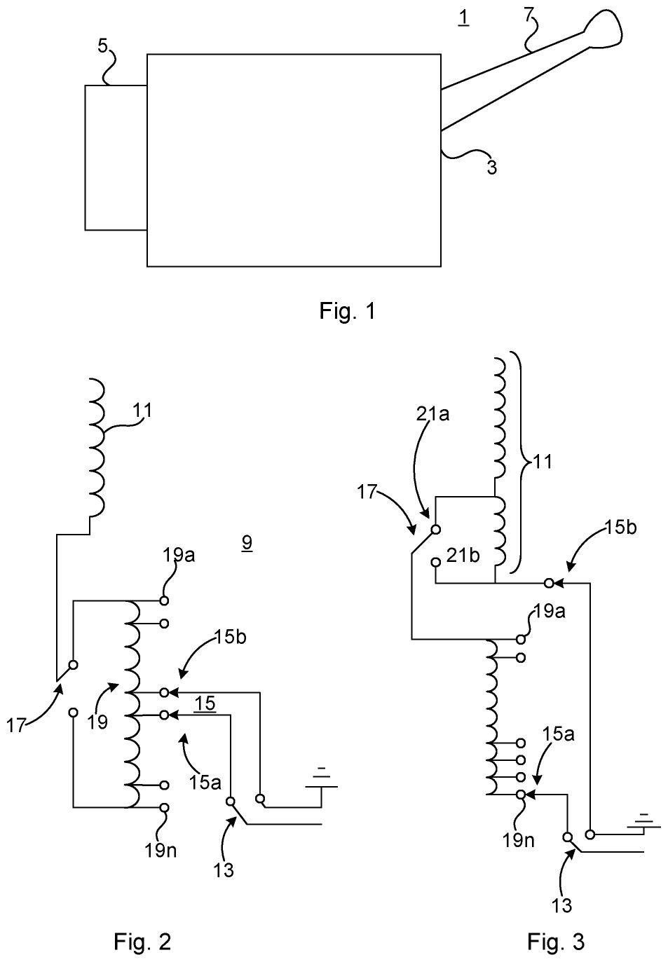

FIG. 1 schematically shows an example of an electromagnetic induction device 1. The electromagnetic induction device 1 may for example be a transformer, such as a power transformer, for example a High Voltage Direct Current (HVDC) converter transformer, or a reactor. The electromagnetic induction device 1 may be a single-phase or multi-phase, such as a three-phase, electromagnetic induction device.

The electromagnetic induction device 1 comprises a main tank 3 and an OLTC tank 5. The electromagnetic induction device 1 comprises a first dielectric liquid. The main tank 3 is filled with the first dielectric liquid. The first dielectric liquid may for example be oil or an ester. The electromagnetic induction device 1 comprises a second dielectric liquid. The OLTC tank 5 is filled with the second dielectric liquid. The second dielectric liquid may for example be an oil or an ester.

The electromagnetic induction device 1 comprises a magnetic core (not shown). The magnetic core may for example comprise a plurality of laminated metal sheets forming one or more limbs. The electromagnetic induction device 1 comprises windings. Each winding is wound around a limb of the one or more limbs of the magnetic core. As is known to the person skilled in the art, the number of limbs and windings typically depends on the number of electrical phases of the electromagnetic induction device 1.

The magnetic core is arranged in the main tank 3. The electromagnetic induction device 1 may also comprise one or more bushings 7 extending through the main tank 3. The one or more bushings are connected to a respective winding.

The electromagnetic induction device 1 comprises an OLTC. FIG. 2 shows an electric diagram of one example of an OLTC 9. FIG. 2 shows a winding 11, referred to as the “tapped winding” of the electromagnetic induction device 1. The OLTC 9 comprises a diverter switch 13, a fine selector 15 comprising movable contacts 15a and 15b, a change-over selector 17, and a customer interface or user interface (not shown in FIG. 2).

The electromagnetic induction device 1 comprises a regulator winding 19. The regulator winding 19 is provided with a plurality of fixed contacts or taps 19a-19n.

The movable contacts 15a, 15b are configured to be moved between the taps 19a-19n of the regulator winding 19. The diverter switch 13 is configured to be connected to either a first movable contact 15a or a second movable contact 15b. When the diverter switch 13 is connected to one of the movable contacts 15a and 15b, the other movable contact 15a, 15b may be moved to another tap 19a-19n. The number of turns used of the regulator winding 19 may thereby be controlled.

In the example shown in FIG. 2, the change-over selector 17 is configured for plus/minus switching. The change-over selector 17 is configured to extend the regulating range by connecting the winding 11 to different ends of the regulating winding 19. The magnetic flux generated by the regulating winding 19 is thereby reversed.

FIG. 3 shows another example of an OLTC 9′. The OLTC 9′ also comprises the diverter switch 13, the fine selector 15 with the movable contacts 15a and 15b and the change-over selector 17. In the example depicted in FIG. 3, the OLTC 9′ has a coarse/fine switching configuration. The winding 11 has a first tap 21a somewhere between the two ends of the winding 11 and a second tap 21b at an end of the winding 11. The change-over selector 17 is configured to be connected to either the first tap 21a or the second tap 21b. The voltage range of the regulating range may thereby be extended.

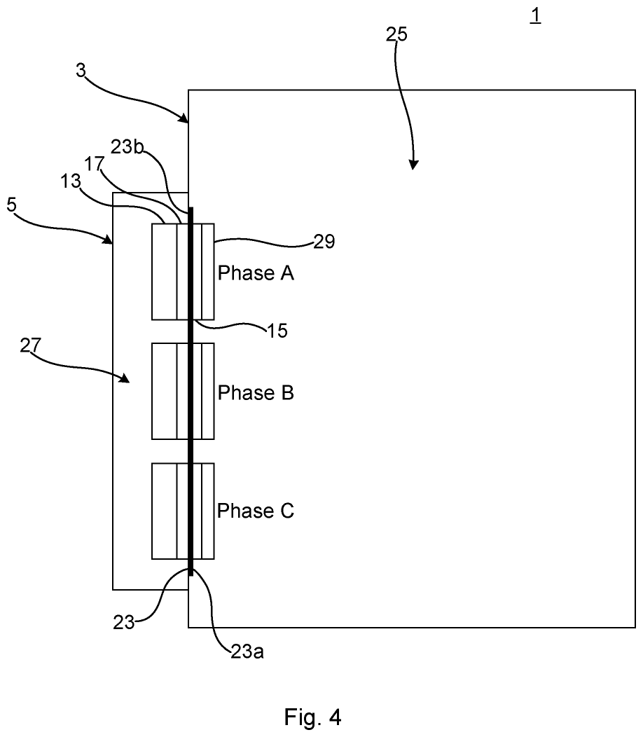

FIG. 4 schematically shows a longitudinal section of the electromagnetic induction device 1 exemplified as a three-phase electromagnetic induction device, with phases A, B and C. The same principles as will be described below also hold for an electromagnetic induction device with fewer or more electrical phases than three.

The electromagnetic induction device 1 comprises a barrier 23. The barrier 23 is configured to separate the main tank 3 from the OLTC tank 5. The main tank 3 is filled with the first dielectric liquid 25. The OLTC tank 5 is filled with the second dielectric liquid 27. The barrier 23 is configured to separate the first dielectric liquid 25 from the second dielectric liquid 27.

The barrier 23 may comprise an electrically insulating material. The barrier 23 may for example comprise a polymer-based material such as epoxy and/or glass fiber. The barrier 23 forms a wall which separates the main tank 3 and the OLTC tank 5.

The barrier 23 has a main tank side 23a and an OLTC side 23b. The main tank side 23a is arranged opposite to the OLTC side 23b. The main tank side 23a faces the interior of the main tank 3. The OLTC side 23b faces the interior of the OLTC tank 5.

The following description will be with reference to a single electrical phase, in this case phase A. The same structure applies to the other phases too.

The diverter switch 13 and the change-over selector 17 are arranged in the OLTC tank 5. The diverter switch 13 and the change-over selector 17 are arranged in the dielectric liquid volume containing the second dielectric liquid 27. The diverter switch 13 and the change-over selector 17 are hence in liquid contact with the second dielectric liquid 27.

The fine selector 15 and the customer interface 29 is arranged in the main tank 3. The fine selector 15 and the customer interface 29 are in liquid contact with the first dielectric liquid 25 The fine selector 15 and the customer interface 29 hence share dielectric liquid with the other components, such as the magnetic core and the windings contained in the main tank 3.

According to the example shown in FIG. 4, the change-over selector 17 is arranged between the barrier 23 and the diverter switch 13. The change-over selector 17 and the diverter switch 13 may be integrated.

The change-over selector 17 and the diverter switch 13 may be mounted to the barrier 23. The change-over selector 17 and the diverter switch 13 may be mounted to the OLTC side 23b of the barrier 23.

According to the example shown in FIG. 4, the fine selector 15 is arranged between the barrier 23 and the customer interface 29. The fine selector 15 and the customer interface 29 may be integrated.

The fine selector 15 and the customer interface 29 may be mounted to the barrier 23. The fine selector 15 and the customer interface 29 may be mounted to the main tank side 23a of the barrier 23.

The barrier 23 is provided with a plurality of electrical connections. The electrical connections provide electrical connection between the diverter switch 13, the change-over selector 17, and the fine selector 15. Transfer of mechanical movement via rotating axles of the components of the OLTC is also provided through the barrier 23.

The present disclosure has mainly been described above with reference to a few examples. However, as is readily appreciated by a person skilled in the art, other embodiments than the ones disclosed above are equally possible within the scope of the present disclosure, as defined by the appended claims.

1. An electromagnetic induction device comprising:
a main tank,
a magnetic core arranged in the main tank,
an On-Load Tap Changer, OLTC, comprising:
an OLTC tank mounted to the main tank,
a fine selector,
a diverter switch,
a change-over selector, and
a customer interface; and
a barrier separating the main tank from the OLTC tank, wherein the diverter switch and the change-over selector are arranged in the OLTC tank, and the fine selector and customer interface are arranged in the main tank, and wherein the barrier comprises a plurality of electrical connections configured to connect the diverter switch and the change-over selector to the fine selector.

2. The electromagnetic induction device as claimed in claim 1, wherein the main tank is filled with a first dielectric liquid and the OLTC tank is filled with a second dielectric liquid, and wherein the barrier separates the first dielectric liquid from the second dielectric liquid.

3. The electromagnetic induction device as claimed in claim 1, wherein the diverter switch and the change-over selector are arranged on an OLTC side of the barrier.

4. The electromagnetic induction device as claimed in claim 3, wherein the change-over selector is arranged between the diverter switch and the barrier.

5. The electromagnetic induction device as claimed in claim 3, wherein the fine selector and customer interface are arranged on a main tank side of the barrier.

6. The electromagnetic induction device as claimed in claim 5, wherein the fine selector is arranged between the customer interface and the barrier.

7. The electromagnetic induction device as claimed in claim 1, wherein the barrier comprises an electrically insulating material.

8. The electromagnetic induction device as claimed in claim 1, wherein the barrier comprises a polymer-based material.

9. The electromagnetic induction device as claimed in claim 1, wherein the barrier comprises at least one of glass fiber and epoxy.

10. The electromagnetic induction device as claimed in claim 1, wherein the electromagnetic induction device is a high voltage electromagnetic induction device, wherein the high voltage comprises voltages between 36 kV and 145 kV.

11. The electromagnetic induction device as claimed in claim 1, wherein the electromagnetic induction device is a transformer or a reactor.

12. The electromagnetic induction device as claimed in claim 2, wherein the diverter switch and the change-over selector are arranged on an OLTC side of the barrier.

13. The electromagnetic induction device as claimed in claim 4, wherein the fine selector and customer interface are arranged on a main tank side of the barrier.

14. The electromagnetic induction device as claimed in claim 13, wherein the fine selector is arranged between the customer interface and the barrier.

15. The electromagnetic induction device as claim in claim 1, wherein the OLTC is a single phase OTLC.

16. The electromagnetic induction device as claimed in claim 1, wherein the OLTC is a two phase OTLC, each phase of the two phase OTLC comprising a respective fine selector, diverter switch, change-over selector and customer interface, the diverter switch and change-over selector of each phase of the two phase OTLC being arranged in the OLTC tank and the fine selector and the customer interface of each face being arranged in the main tank.

17. The electromagnetic induction device as claimed in claim 16 wherein each diverter switch and change-over selector may be mounted to an OLTC side of the barrier.

18. The electromagnetic induction device as claimed in claim 1, wherein the OLTC is a three phase OTLC, each phase of the three phase OTLC comprising a respective fine selector, diverter switch, change-over selector and customer interface, the diverter switch and change-over selector of each phase of the three phase OTLC being arranged in the OLTC tank and the fine selector and the customer interface of each face being arranged in the main tank.

19. The electromagnetic induction device as claimed in claim 16 wherein each diverter switch and change-over selector may be mounted to an OLTC side of the barrier.

20. A transformer comprising:
a main tank,
a magnetic core arranged in the main tank,
an On-Load Tap Changer, OLTC, comprising:
an OLTC tank mounted to the main tank,
a fine selector,
a diverter switch,
a change-over selector, and
a customer interface; and
a barrier separating the main tank from the OLTC tank, wherein the diverter switch and the change-over selector are arranged in the OLTC tank, and the fine selector and customer interface are arranged in the main tank, and wherein the barrier comprises a plurality of electrical connections configured to connect the diverter switch and the change-over selector to the fine selector.
